(19) United States
(12) Patent Application Publication
(10) Pub. No.: US 2008/0157513 A1
(43) Pub. Date: Jul. 3, 2008

(54) Anti-tip assembly for a power wheelchair

(75) Inventor: Ming-Chuan Cheng, Taichung (TW)

Correspondence Address: COOPER & DUNHAM, LLP, 1185 AVENUE OF THE AMERICAS, NEW YORK, NY, 10036, US

(73) Assignee: Merits Health Products Co., Ltd.

(21) Appl. No.: 11/647,866

(22) Filed: Dec. 29, 2006

(51) Int. Cl. A61G 5/10; A61G 5/04

(52) U.S. Cl. 280/755

(57) ABSTRACT

An anti-tip assembly for a power wheelchair with a frame and has a resilient bracket and a front wheel assembly. The resilient bracket has a mounting bracket, a resilient arm and a resilient wheel connector. The mounting bracket is connected to the frame and has a top edge. The resilient arm is formed on and protrudes forward from the top edge of the mounting bracket and has a distal end. The resilient wheel connector is formed on and extends from the distal end of the resilient arm and has a bottom leg. The front wheel assembly is connected securely to the bottom leg of the resilient wheel connector and has a wheel bracket and an idler wheel. The wheel bracket is connected to the bottom leg of the resilient wheel connector and has two wings. The idler wheel is mounted rotatably between the wings.

### BACKGROUND OF THE INVENTION

1. Field of the Invention

The present invention relates to an anti-tip assembly, and more particularly to an anti-tip assembly used on a power wheelchair.

2. Description of Related Art

With reference to FIG. 8, a conventional power wheelchair (70) has a frame (701), a motor, two drive wheels (71), two rear wheels (72) and two front wheel devices (73). The frame (701) has a top, a front end, a rear end and a seat. The seat is mounted on the top of the frame to hold a person. The motor is mounted on the frame (701) below the seat. The drive wheels (71) are connected rotatably to the frame (701) below the seat and are driven by the motor. The rear wheels (72) are connected pivotally and rotatably to the rear end of the frame (701). The front wheel devices (73) are connected rotatably to and protrude from the front end of the frame (701), and each front wheel device (73) has a mounting arm (731), an idler wheel (732) and an axle (733).

Each mounting arm (731) is connected to and protrudes from the front end of the frame (701) and has a proximal end, a distal end and a mounting hole. The proximal end of the mounting ram (731) is connected securely to the frame (701) at the front end. The mounting hole is formed through the mounting arm (731) near the distal end.

The idler wheel (732) is connected rotatably to the distal end of the mounting arm (731).

The axle (733) extends through the mounting hole and the idler wheel (732) and attaches the idler wheel (732) rotatably to the mounting arm (731).

However, the conventional wheelchair (70) has a number of disadvantages. When the mounting frame (731) of the front wheel device (73) is heavy and stiff, the power wheelchair (70) provides an uncomfortable ride on rugged and rough ground and cannot traverse obstacles easily.

A light and flexible mounting frame (731) on the front wheel device (73) makes the mounting frames (731) susceptible to being bent, which could easily result in the power wheelchair (70) tipping over and injuring a person in the power wheelchair (70).

The anti-tip assembly for a power wheelchair in accordance with the present invention mitigates or obviates the aforementioned problems.

### SUMMARY OF THE INVENTION

The main objective of the present invention is to provide an anti-tip assembly for a power wheelchair so the power wheelchair can be used safely.

The anti-tip assembly for a power wheelchair with a frame and has a resilient bracket and a front wheel assembly. The resilient bracket has a mounting bracket, a resilient arm and a resilient wheel connector. The mounting bracket is connected to the frame and has a top edge. The resilient arm is formed on and protrudes forward from the top edge of the mounting bracket and has a distal end. The resilient wheel connector is formed on and extends from the distal end of the resilient arm and has a bottom leg. The front wheel assembly is connected securely to the bottom leg of the resilient wheel connector and has a wheel bracket and an idler wheel. The wheel bracket is connected to the bottom leg of the resilient wheel connector and has two wings. The idler wheel is mounted rotatably between the wings. Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an anti-tip assembly in accordance with the present invention;

FIG. 2 is an exploded perspective view of the anti-tip assembly in FIG. 1;

FIG. 3 is a side view of the anti-tip assembly in FIG. 1 on a power wheelchair;

FIG. 4 is an operational side view of the anti-tip assembly in FIG. 3 when the power wheelchair tips forward;

FIG. 4A is an enlarged side view of the anti-tip assembly in FIG. 4;

FIG. 5 is an operational side view of the power wheelchair in FIG. 3 stopping on a downward slope;

FIG. 6 is an operational side view of the power wheelchair in FIG. 3 when the anti-tip assembly contacts an obstacle;

FIG. 7 is an operational side view of the power wheelchair in FIG. 6 as the anti-tip assembly flexes to traverse the obstacle; and

FIG. 8 is a side view of a power wheelchair with a conventional anti-tip assembly in accordance with the prior art.

### DETAILED DESCRIPTION OF THE PREFERRED EMBODIMENT

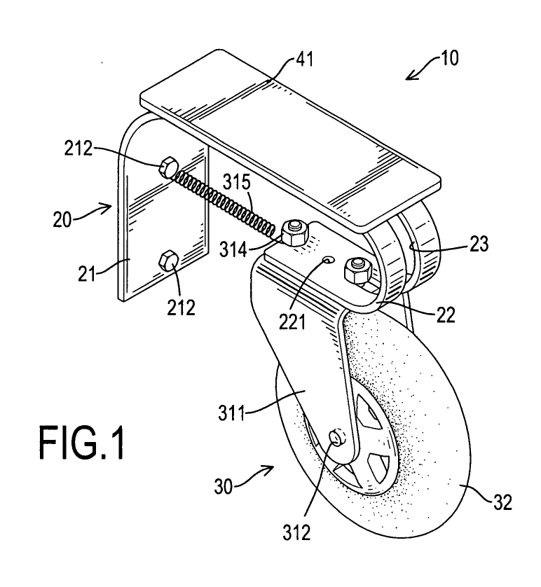

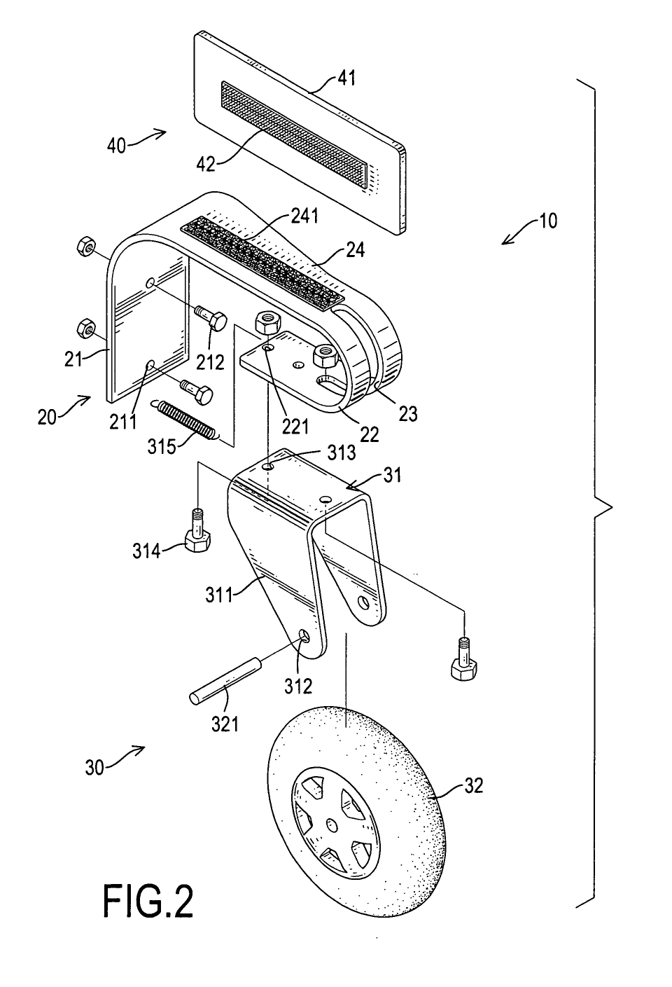

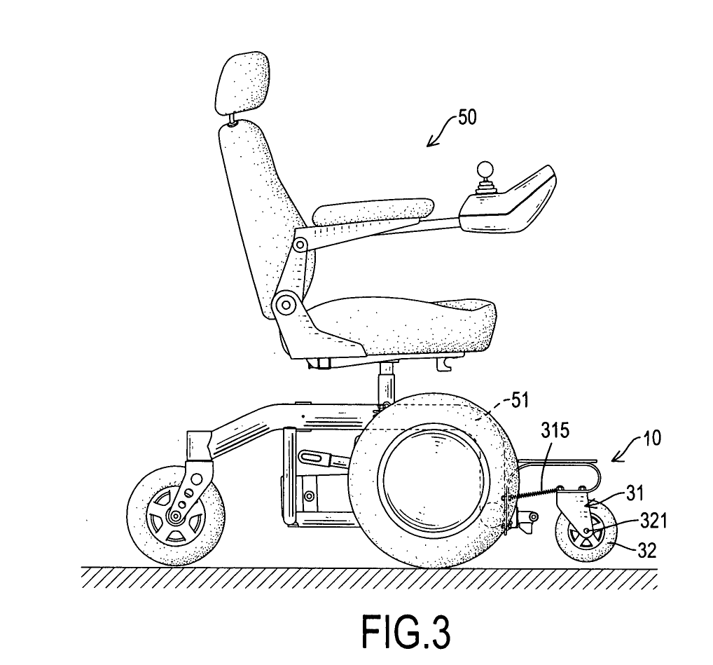

With reference to FIGS. 1 to 3, an anti-tip assembly (10) in accordance with the present invention for a power wheelchair (50) with a frame (51) is connected to the frame (51) of the power wheelchair (50) and has a resilient bracket (20), a front wheel assembly (30) and an optional footrest (40).

The resilient bracket (20) may be L-shaped, is connected securely to the frame (51) of the power wheelchair (50) and has a mounting bracket (21), a resilient arm (24) and a resilient wheel connector (22).

The mounting bracket (21) is connected to the frame (51) of the power wheelchair (50) and has a top edge, multiple optional mounting holes (211) and multiple optional fasteners (212). The mounting holes (211) are formed through the mounting bracket (21). The fasteners (212) extend respectively through the mounting holes (211), connect the mounting bracket (21) to the frame (51) and may be bolts.

The resilient arm (24) is formed on and protrudes forward from the top edge of the mounting bracket (21) and has a proximal end, a distal end, a top surface and an optional lower footrest connector (241). The lower footrest connector (241) is formed on the top surface of the resilient arm (24) between the proximal end and the distal end of the resilient arm (24).

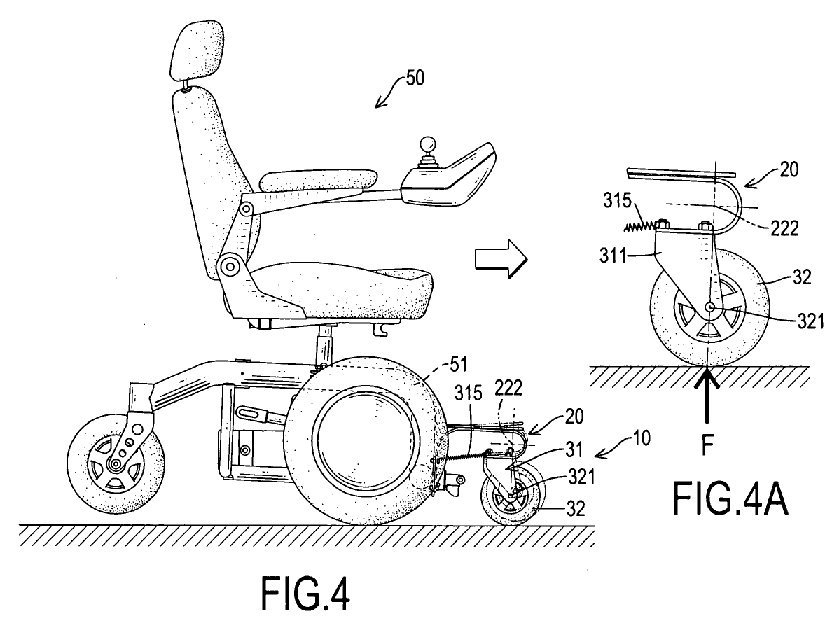

With further reference to FIG. 4, the resilient wheel connector (22) is U-shaped, is formed on and extends from the distal end of the resilient arm (24) and has a proximal end, a bottom leg, a center of curvature (222), multiple optional connecting holes (221) and an optional elongated slot (23). The bottom leg is parallel to the resilient arm (24).

With further reference to FIG. 4A, the center of curvature is between the proximal end of the resilient wheel connector (22) and the bottom leg. The connecting holes (221) are formed through the bottom leg of the resilient wheel connector (22). The elongated slot (23) is formed longitudinally in the resilient wheel connector (22) from the distal end into the bottom leg.

The front wheel assembly (30) is connected securely to the bottom leg of the resilient wheel connector (22) and has a wheel bracket (31) and an idler wheel (32).

The wheel bracket (31) is U-shaped, is connected to the bottom leg of the resilient wheel connector and has a top, two wings (311), multiple optional fasteners (314) and an optional spring (315).

The top of the wheel bracket (31) is connected to the bottom leg of the resilient wheel connector (22) and has multiple optional through holes (313). The through holes (313) are formed through the top of the wheel bracket (31) and align with the mounting holes (211) and the elongated slot (23) in the bottom leg of the resilient wheel bracket (22). The wings (311) of the wheel bracket (31) are formed on and protruded down the top of the wheel bracket (31) parallel to each other, and each wing (311) has a distal end and an axle hole (312). The axle holes (312) are formed respectively through the wings (311) of the wheel bracket (31) immediately below the center of curvature (222) of the resilient wheel connector (22) and align with each other. The fasteners (314) extend respectively through the through holes (313) and corresponding connecting holes (221) and the elongated slot (23) in the resilient wheel connector (22) to connect the wheel bracket (31) to the resilient wheel bracket (22). The spring (315) is attached to one of the fasteners (212) in the mounting bracket (21) and one of the fasteners (314) in the wheel bracket (31).

The idler wheel (32) is connected rotatably to the wheel bracket (31), is suspended slightly above a flat surface on which the power wheelchair (50) rests and has a center, an axle hole and an axle (321). The axle hole is formed through the center of the idler wheel (32). The axle (321) is mounted securely in the axle holes (312) in the wings (311) and extends rotatably through the axle hole in the idler wheel (32) to hold the wheel (32) rotatably in the wheel bracket (31).

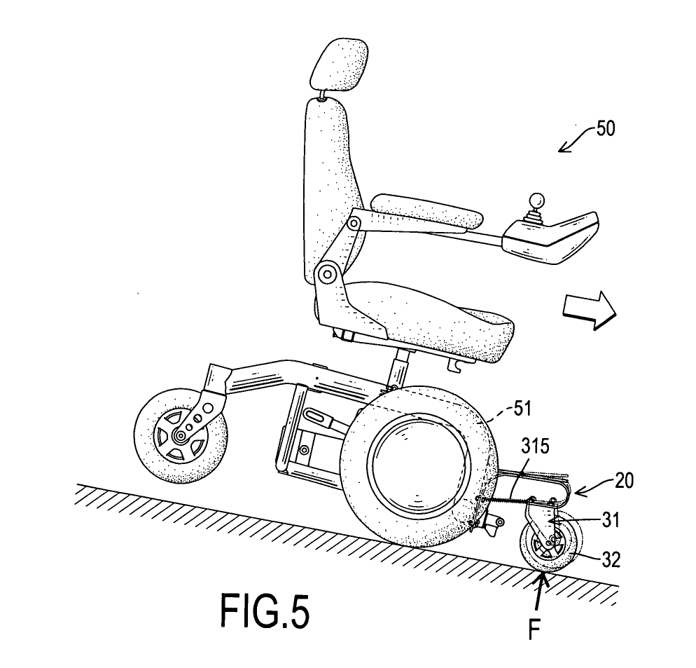

With further reference to FIGS. 4, 4A and 5, the idler wheel (32) will contact with the ground when the power wheelchair (50) is stops abruptly or slows down or stops on a downhill path, which will generate a reacting force (F). The reacting force (F) is transmitted to the front wheel assembly (30) and passes through the center of curvature (222) of the resilient wheel connector (22). The bottom leg of the resilient wheel connector (22) bends toward the resilient arm (24) and absorbs virtually all of the reacting force (F) when the idler wheel (32) lifts up. This can prevent the power wheelchair (50) form tipping over when the power wheelchair (50) is stops abruptly or slows down or stops on a downhill path. Consequently, the power wheelchair (50) will not tip over, a person in the power wheelchair (50) will not be injured.

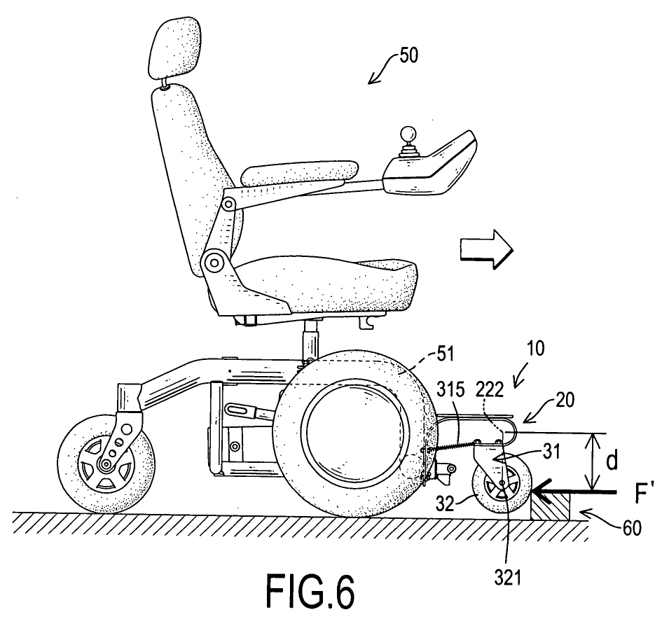

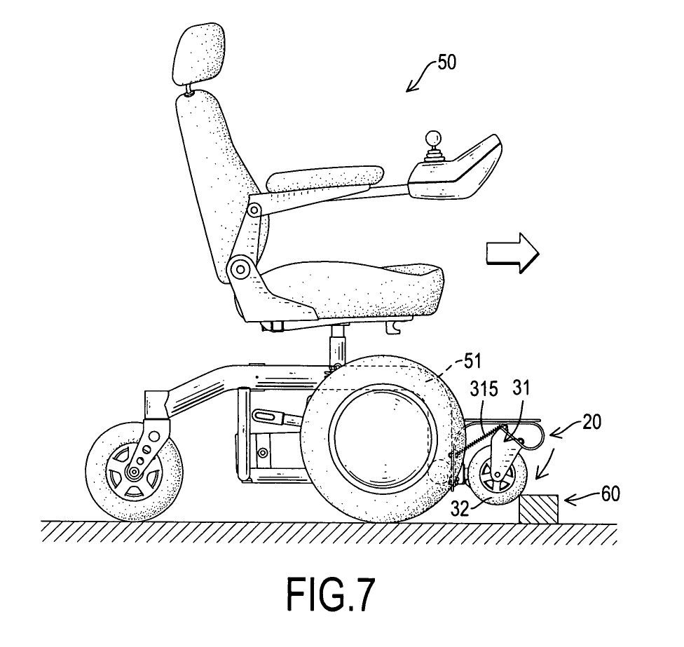

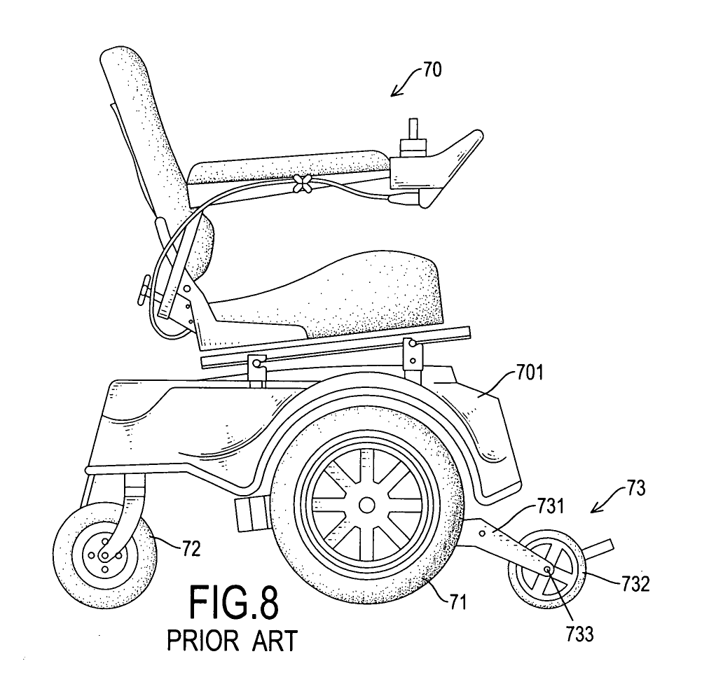

With reference to FIGS. 6 and 7, when the power wheelchair (50) encounters an obstacle (60) and generates a reacting force (F′) from the idler wheel (32) striking the obstacle (60) a distance (d) from the center of curvature (222) which generates a moment applied to the wheel assembly (30). The moment of force will bend the resilient wheel bracket (22) and the resilient arm (24) so the idler wheel (32) will rise and traverse the obstacle (60).

The footrest (40) is connected to the resilient bracket (20) and has a footplate (41) and an upper footrest connector (42). The footplate (41) is mounted on the top of the resilient arm (24) between the mounting bracket (21) and the resilient wheel connector (22) and has a bottom surface. The upper footrest connector (42) is formed on the bottom surface of the footplate (41) and is connected to the lower footrest connector (241) on the top surface of the resilient arm (24).

The anti-tip assembly (10) as described has the following advantages.

1. When the power wheelchair (50) stops abruptly or stops or slows down on a downhill path, the reacting force (F) generated by the idler wheel (32) contacting the ground will not permanently deform the anti-tip assembly (10). This can prevent the power wheelchair (50) from tipping over when the power wheelchair (50), and a person in the power wheelchair (50) will not be injured.

2. When the power wheelchair (50) encounters an obstacle (60), the moment acting on the idler wheel (32) bends the resilient wheel bracket (22) and the resilient arm (24) so the idler wheel (32) rises and traverses the obstacle (60) easily.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An anti-tip assembly for a power wheelchair with a frame and comprising
a resilient bracket to be connected securely to the power wheelchair and having
a mounting bracket to be connected to the frame of the power wheelchair and having a top edge;
a resilient arm being formed on and protruding forward from the top edge of the mounting bracket and having
a proximal end;
a distal end; and
a top surface; and
a resilient wheel connector being U-shaped, being formed on and extending from the distal end of the resilient arm and having
a proximal end;
a bottom leg being parallel to the resilient arm; and
a center of curvature being between the proximal end of the resilient wheel connector and the bottom leg of the resilient wheel connector; and
a front wheel assembly being connected securely to the bottom leg of the resilient wheel connector and having
a wheel bracket being connected to the bottom leg of the resilient wheel connector and having
a top being connected to the bottom leg of the resilient wheel connector; and
two wings being formed on and protruded down the top of the wheel bracket parallel to each other, and each wing having
a distal end; and
an axle hole being formed through the wing immediately below the center of curvature of the resilient wheel connector; and
an idler wheel being connected rotatably to the wheel bracket to be suspended slightly above a flat surface on which the power wheel chair rest and having
a center;
an axle hole being formed through the center of the idler wheel; and
an axle mounted securely in the axle holes in the wings and extending rotatably through the axle hole in the idler wheel.

2. The anti-tip assembly as claimed in claim 1, wherein
the resilient arm further has a lower footrest connector;
the anti-tip assembly further has a footrest being connected to the resilient bracket and having
a footplate being mounted on the top of the resilient arm between the mounting bracket and the resilient wheel connector and having a bottom surface; and
an upper footrest connector being formed on the bottom surface of the footplate and being connected to the lower footrest connector on the top surface of the resilient arm.

3. The anti-tip assembly as claimed in claim 1, wherein
the mounting bracket further has
multiple mounting holes being formed through the mounting bracket; and
multiple fasteners extending respectively through the mounting holes to connect the mounting bracket to the frame of the power wheelchair;
the resilient wheel connector further has
multiple connecting holes being formed through the bottom leg of the resilient wheel connector; and
an elongated slot being formed longitudinally in the resilient wheel connector from the distal end into the bottom leg;
the top of the wheel bracket has multiple through holes being formed through the top of the wheel bracket and aligning with the mounting holes and the elongated slot in the bottom leg of the resilient wheel bracket; and
the wheel bracket further has
multiple fasteners being extended respectively through the through holes and corresponding mounting holes and the elongated groove in the resilient wheel connector to connect the wheel bracket to the resilient wheel bracket; and
a spring being attached to one of the fasteners in the mounting bracket and one of the fasteners in the wheel bracket.

4. The anti-tip assembly as claimed in claim 1, wherein the resilient bracket is L-shaped.

5. The anti-tip assembly as claimed in claim 2, wherein
the mounting bracket further has
multiple mounting holes being formed through the mounting bracket; and
multiple fasteners extending respectively through the mounting holes to connect the mounting bracket to the frame of the power wheelchair;
the resilient wheel connector further has
multiple connecting holes being formed through the bottom leg of the resilient wheel connector; and
an elongated slot being formed longitudinally in the resilient wheel connector from the distal end into the bottom leg; and
the top of the wheel bracket has multiple through holes being formed through the top of the wheel bracket and aligning with the mounting holes and the elongated slot in the bottom leg of the resilient wheel bracket; and
the wheel bracket further has
multiple fasteners being extended respectively through the through holes and corresponding mounting holes and the elongated groove in the resilient wheel connector to connect the wheel bracket to the resilient wheel bracket; and
a spring being attached to one of the fasteners in the mounting bracket and one of the fasteners in the wheel bracket.

6. The anti-tip assembly as claimed in claim 5, wherein the fasteners of the mounting bracket are bolts.

7. The anti-tip assembly as claimed in claim 5, wherein the resilient bracket (20) is L-shaped.
